(19) United States
(12) Patent Application Publication
(10) Pub. No.: US 2004/0242336 A1
(43) Pub. Date: Dec. 2, 2004

(54) Resilient sleeve for a splined connection

(76) Inventors: Michael Williamson, Newport (GB); Mark Batchelor, Newport (GB); Andrew John Blewitt, Cwmbran (GB); Peter Esau, Cwmbran (GB)

Correspondence Address: CARLSON, GASKEY & OLDS, P.C., 400 WEST MAPLE ROAD, SUITE 350, BIRMINGHAM, MI, 48009, US

(21) Appl. No.: 10/852,310

(22) Filed: May 24, 2004

(30) Foreign Application Priority Data
May 24, 2003 (GB) 0312045.8

(51) Int. Cl. F16D 3/52

(52) U.S. Cl. 464/89

(57) ABSTRACT

A resilient sleeve includes a splined sleeve surface for engagement with an external spline of a first rotary member or an internal spline of a second rotary member. The resilient sleeve has a further splined sleeve surface for engagement with a further spline of the first rotary member or the second rotary member to inhibit relative movement between the rotary members. The first rotary member can be a part of a drive shaft, and the second rotary member can be a disc brake.

### REFERENCE TO RELATED APPLICATION

This application claims priority to Great Britain Patent Application GB 0312045.8 filed on May 24, 2003.

1. Technical Field

The present invention relates to a device for reducing an effect of mechanical hysteresis in a splined connection. More specifically, the present invention relates to device that reduces the effect of mechanical hysteresis between an internally splined brake disc and an externally splined part of a drive shaft.

2. Background of the Invention

Mechanical hysteresis exists between splined members of a driven rotary connection. This mechanical hysteresis, commonly referred to as backlash or play, can generate unwanted noise and vibration in the connection. The noise, which is typically a rattling noise, is produced by relative movement between the intermeshed internal and external splines, which causes the splines to strike each other.

In some embodiments, the noise can be reduced by reducing the clearance between the splined members. However, this can lead to an increased likelihood of the splined members jamming, particularly under repeated thermal expansion and contraction.

There is a compromise in selecting a spline clearance that minimizes the noise and vibration in the splined connection while preventing the possible jamming of the splined members. The compromise can be difficult to achieve because the environment in which the splined connection operates must be taken into account. A typical splined connection is disclosed in European Patent No. EP1091136 issued to Meritor Heavy Vehicle Braking Systems UK Ltd.

A sleeve can be inserted between the splined members to bias the splined members towards one another and thereby take up any play in the connection, as disclosed in French Patent No. FR 2 749 258 issued to Duchene & Mouhot. A drawback is that the device is arranged in the drive path of the connection, requiring the device to withstand the transmission load between the splined members.

A series of retaining clips have been employed to bias the splined members towards each other, as disclosed in European Patent No. EP1158197. A drawback to this arrangement is that the internal spline member needs additional machining to receive the retaining clips. Additionally, the biasing clips make assembly more complex.

Therefore, it is an object of the present invention to provide an improved device that reduces the effect of mechanical hysteresis in a splined connection.

### SUMMARY OF THE INVENTION

The present invention provides a continuous resilient sleeve including a splined internal sleeve surface engageable with an external spline of a first rotary member and a further splined internal sleeve surface engageable with a further external spline of a second rotary member to inhibit relative movement between the rotary members. The sleeve surface is displaced radially from the further sleeve surface.

By providing a splined coupling (i.e., an external spline on the first rotary member and an internal spline on the second rotary member) and a further spline on one of the first rotary member or secondary rotary member (i.e., three splines total), the resilient sleeve can utilize one of the splines for the splined coupling and the further spline to reduce the backlash or play between the rotary members. The resilient sleeve maintains the rotary members in a fixed relationship to inhibit relative rotary movement between the rotary members, thereby minimizing spline rattle.

Preferably, the engagement of the resilient sleeve with the external spline of the first rotary member and the further external spline of the second rotary member allows the resilient sleeve to be removed from the transmission path between the rotary members. The radial displacement of the two splined internal sleeve surfaces of the resilient sleeve allows them to engage with the two external splines of the rotary members because the two splined internal sleeve surfaces will lie in two distinct cylindrical regions, radially displaced from one another by the radial depth of the second rotary member.

The longitudinal axis of the resilient sleeve is coaxial with the axis of rotation of the rotary members. A radial plane of the resilient sleeve is defined as any plane that is perpendicular to the axis of rotation of the rotary members. The longitudinal axis of the resilient sleeve exists midway between the longitudinal extremities of the resilient sleeve.

Preferably, the splined internal sleeve surface and the further splined internal sleeve surface have the same number of spline teeth. This provides for the engagement of the resilient sleeve with the second rotary member having concurrently formed internal and external splines.

Preferably, the spline teeth of the splined internal sleeve surface are circumferentially offset from the spline teeth of the further splined internal sleeve surface by 10% to 50% of a tooth pitch, and more preferably by 20% to 30% of the tooth pitch. The offsetting of the spline teeth of the resilient sleeve causes the inter-meshing splines of the first rotary member and the second rotary member to be biased towards each other.

Alternatively, the present invention provides a resilient sleeve having a splined external sleeve surface engageable with an internal spline of a first rotary member and a further splined external sleeve surface engageable with a further internal spline of a second rotary member to inhibit relative movement between the rotary members. The sleeve surface is displaced radially from the further sleeve surface.

Preferably, the second rotary member is a brake disc, such as the known brake disc disclosed in EP1091136. The internal spline of the brake disc is formed by pressing the base section of the brake disc. An external spline in the radial outside surface of the base section of the brake disc is also produced. Therefore, the currently known brake disc manufacturing process does not have to be altered to form the external spline on the brake disc.

The present invention also provides a method of assembling a brake assembly including the steps of providing a part of a drive shaft and a brake sub-assembly having a brake housing, a brake actuator, two brake discs, and a resilient sleeve. The splines of the two brake discs are co-aligned by their splined engagement with the resilient sleeve. The method further includes the step of inserting the part of the drive shaft into the sub-assembly by engaging the external spline of the part of the drive shaft with the aligned internal splines of the two brake discs.

Preferably, the splines of the two brake discs can be aligned before the part of the drive shaft is inserted into the sub-assembly. This simplifies the assembly process because the second brake disc does not have to be engaged by a process of trial and error. This is particularly advantageous when assembling brakes that are “fail safe”, that is, brakes in which the braking force is applied by a strong spring and brake release is achieved by compressing the spring, typically by a hydraulic or pneumatic system. When assembling fail safe brakes, e.g., on a production line, the hydraulic or pneumatic actuation system may not be available, and it may be necessary to provide tooling to ensure all the splines are correctly aligned. If the splines are misaligned, it can be very difficult to release the brake to allow relative rotation of the brake discs for assembly because of the fail safe spring. The sleeve of present invention aligns the brake discs, thereby obviating the need for a separate alignment tool.

### BRIEF DESCRIPTION OF THE DRAWINGS

A resilient sleeve in accordance with the invention will now be described, by way of example only, with reference to the accompanying drawings in which:

FIG. 1a schematically illustrates an end view of a resilient sleeve in accordance with the present invention;

FIG. 1b schematically illustrates a side view of the resilient sleeve of FIG. 1a sectioned along line IB-IB, with a portion shown in greater detail; and

FIG. 2 illustrates a part-sectioned side view of a brake assembly showing the resilient sleeve of FIG. 1.

### DETAILED DESCRIPTION OF THE PREFERRED EMBODIMENT

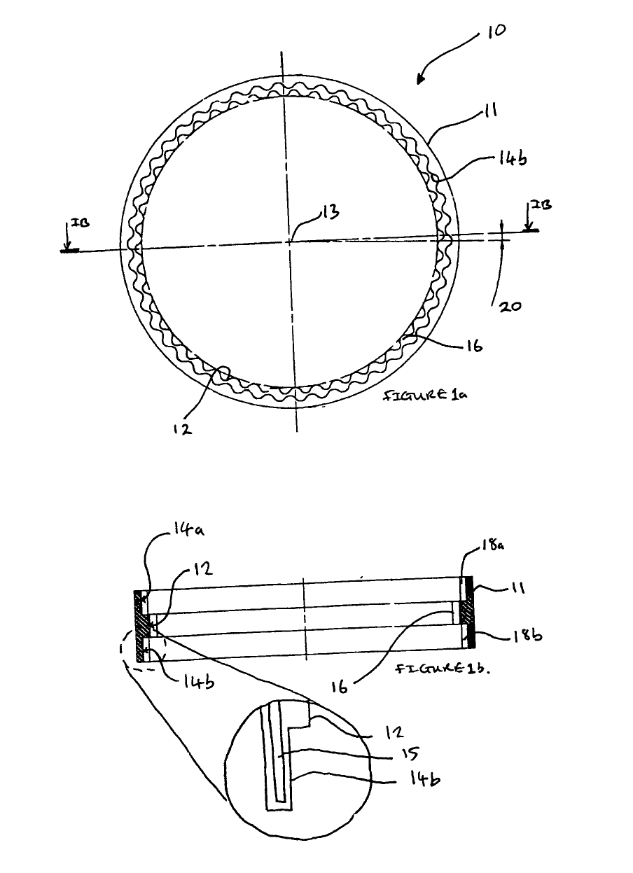

FIGS. 1a and 1b illustrate a resilient sleeve 10 having a substantially circular outer profile 11. An inner profile is formed by a first sleeve surface 12 located between a second sleeve surface 14a and a third sleeve surface 14b. The first sleeve surface 12 is raised from the second sleeve surface 14a and the third sleeve surface 14b in a direction towards a center 13 of the resilient sleeve 10. The first sleeve surface 12 defines a set of spline teeth 16, and the second sleeve surface 14a and the third sleeve surface 14b each define a set of spline teeth 18a and 18b, respectively. The first sleeve surface 12, the second sleeve surface 14a and the third sleeve surface 14b each have the same number of teeth. An offset 20 is located between the spline teeth 16 of the first sleeve surface 12 and the spline teeth 18a of the second sleeve surface 14a, which equates to 0.1 to 0.5 of a tooth pitch, in this example. The spline teeth 18a of the second sleeve surface 14a and the spline teeth 18b of the third sleeve surface 14b are aligned.

The tooth pitch of the first sleeve surface 12 can be calculated by multiplying the tooth pitch of the second sleeve surface 14a by the ratio of the diameter of the first sleeve surface 12 to the diameter of the second sleeve surface 14a.

As shown in FIG. 1b, the first sleeve surface 12 is arranged such that the second sleeve surface 14a and the third sleeve surface 14b have equal areas. The first sleeve surface 12 is disposed on the resilient sleeve 10 such that an axis of symmetry exists about the longitudinal axis of the resilient sleeve 10.

An annular internal reinforcement 15, such as a metal band, is embedded within the resilient sleeve 10. The internal reinforcement 15 prevents the resilient sleeve 10 from expanding under centrifugal acceleration that is experienced when rotating at high speeds. The mode of rotation of the resilient sleeve 10 will be discussed further below. It is also within the scope of the invention that the internal reinforcement 15 could be formed from an alternative material, such as cotton braid, carbon fiber or glass fiber and that the internal reinforcement 15 may or may not have a unitary annular construction.

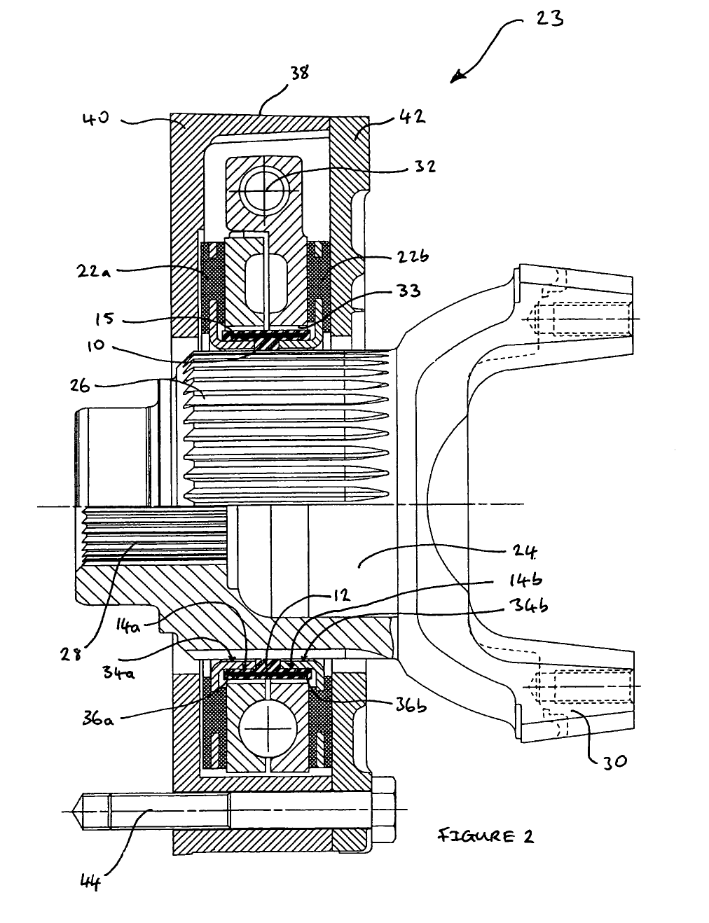

As shown in FIG. 2, a brake assembly 23 (in this case a transmission brake assembly) includes a brake housing 38, two brake discs 22a and 22b, a brake actuator 32, the resilient sleeve 10, and a coupling 24. The coupling 24 forms part of a drive shaft connecting a gear box (not shown) to further parts of a transmission assembly (not shown).

The brake actuator 32 is a ball and ramp actuator, which is well known in the art. Operation of the brake actuator 32 causes the displacement of balls on ramps located between two halves of the brake actuator 32, causing a longitudinal separation of the two halves of the brake actuator 32 and applying a load to the brake discs 22a and 22b. This load is reacted by two halves 40 and 42 of the brake housing 38, as described above.

An annular space 33 between the resilient sleeve 10 and the brake actuator 32 provides clearance for the rotation of the resilient sleeve 10 with respect the brake actuator 32. The annular space 33 also allows the resilient sleeve 10 to expand during high speed rotation, although it will be noted that the expansion is negligible given the presence of the internal reinforcement 15 within the resilient sleeve 10.

The coupling 24 (also known as a first rotary member) has an external spline 26, an internal input spline 28 for driven engagement with an output shaft of a gearbox (not shown for clarity) and an output 30 forming one half of a universal joint connection.

The brake disc 22a (also known as a second rotary member) has an internal spline 34a and an external spline 36a (also known as a further spline). Similarly, the brake disc 22b (also known as a third rotary member) has an internal spline 34b and an external spline 36b (also known as a further spline). The internal splines 34a and 34b and the external splines 36a and 36b are formed concurrently during manufacture of the brake discs 22a and 22b, typically by pressing. The external spline 36a of the brake disc 22a engages with the spline teeth 18a of the second sleeve surface 14a, and the external spline 36b of the brake disc 22b engages with spline teeth 18b of the third sleeve surface 14b. The internal splines 34a and 34b of the respective brake discs 22a and 22b engage with the external spline 26 of the coupling 24.

The spline teeth 16 of the first sleeve surface 12 engage with the external spline 26 of the coupling 24, and the spline teeth 18a and 18b of the second sleeve surface 14a and the third sleeve surface 14b, respectively, engage with the external splines 36a and 36b of the respective brake discs 22a and 22b.

The offset 20 of the spline teeth 16 of the first sleeve surface 12 relative to the spline teeth 18a and 18b of the second sleeve surface 14a and the third sleeve surface 14b, respectively, ensures that the splines 34a and 36a of the brake disc 22a, the splines 34b and 36b of the brake disc 22b, and the splines 26 and 28 of the coupling 24 are rotationally biased by the resilient sleeve 10 to be in contact. This inhibits relative rotary movement of the coupling 24, the brake disc 22a and the brake disc 22b, thereby reducing noise and wear to the spline teeth 16, 18a and 18b.

The spline teeth of one of the rotary members are biased towards the spline teeth of the other rotary member in a predetermined direction of rotation of the coupling 24. The brake assembly 23 acts as a transmission parking brake and is mounted to a vehicle gearbox by mounting bolts 44, as shown in FIG. 2.

It is within the scope of the invention that the brake assembly be mounted elsewhere on the driveline of the vehicle, for example, at the rear of the drive shaft and bolted to the vehicle rear axle differential casing.

In parking brakes, a brake drag can occur when the brake does not fully disengage. Consequently, the offset 20 is preferably arranged such that the spline teeth 16 of the first sleeve surface 12 are offset with respect to the spline teeth 18a of the second sleeve surface 14a in the direction of rotation of the drive shaft that is observed when a vehicle having the brake is travelling forward. Any brake drag forces the already contacting surfaces of the external splines 26 of the coupling 24 and the internal splines 34a and 34b of the brake discs 22a and 22b, respectively, and the already contacting surfaces of the external splines 26 of the coupling 24 and the spline teeth 16 of the resilient sleeve 10 further into engagement. The appropriate spline surfaces always contact, and thus no noise is generated by spline rattle.

In further embodiments, the first sleeve surface 12 and/or the second sleeve surface 14a could be arranged to be an interference fit on their associated rotary component, also preventing spline rattle. When present, the third sleeve surface 14b could also be arranged to be an interference fit on its associated component.

In yet further embodiments, combinations of offset sleeve splines and interference fit arrangements could be used to prevent spline rattle.

Alternatively, the resilient sleeve 10 described above can including a first splined external sleeve surface for engagement with a first internal spline of a first rotary member and a second splined external sleeve surface for engagement with a second internal spline of a second rotary member so as to inhibit relative movement between the first rotary member and the second rotary member. The first splined external sleeve surface is displaced radially from the second splined external sleeve surface.

The foregoing description is only exemplary of the principles of the invention. Many modifications and variations of the present invention are possible in light of the above teachings. The preferred embodiments of this invention have been disclosed, however, so that one of ordinary skill in the art would recognize that certain modifications would come within the scope of this invention. It is, therefore, to be understood that within the scope of the appended claims, the invention may be practiced otherwise than as specifically described. For that reason the following claims should be studied to determine the true scope and content of this invention.

What is claimed is:

1. A resilient sleeve comprising:
a first splined internal sleeve surface for engagement with a first external spline of a first rotary member; and
a second splined internal sleeve surface for engagement with a second external spline of a second rotary member to inhibit relative movement between the first rotary member and the second rotary member, wherein the first splined internal sleeve surface is displaced radially from the second splined internal sleeve surface.

2. The resilient sleeve in accordance with claim 1 wherein the first splined internal sleeve surface has first spline teeth and the second splined internal sleeve surface has second spline teeth, and wherein the first spline teeth of the first splined internal sleeve surface are circumferentially offset from the second spline teeth of the second splined internal sleeve surface.

3. The resilient sleeve in accordance with claim 2 further comprising a third splined internal sleeve surface for engagement with a third spline of a third rotary member to inhibit relative movement between the first rotary member and the third rotary member.

4. The resilient sleeve in accordance with claim 3 wherein the third splined internal sleeve surface is separated from the second splined internal sleeve surface by the first splined internal sleeve surface.

5. The resilient sleeve in accordance with claim 3 wherein the third splined internal sleeve surface is substantially identical to the second splined internal sleeve surface.

6. The resilient sleeve in accordance with claim 3 wherein the first splined internal sleeve surface is arranged between the second splined internal sleeve surface and the third splined internal sleeve surface to establish an axis of symmetry coaxial with a longitudinal axis of the resilient sleeve.

7. The resilient sleeve in accordance with claim 6 further comprising an internal reinforcement to inhibit centrifugal expansion of the resilient sleeve during rotation.

8. The resilient sleeve in accordance with claim 1 wherein one of the first splined internal sleeve surface and the second splined internal sleeve surface is a surface that is displaced radially outwardly from the other of the first splined internal sleeve surface and the second splined internal sleeve surface, and wherein the surface that is displaced radially outwardly is at an axial end of the resilient sleeve.

9. The resilient sleeve in accordance with claim 1 further comprising an internal reinforcement to inhibit centrifugal expansion of the resilient sleeve during rotation.

10. A resilient sleeve comprising:
a first splined external sleeve surface for engagement with a first internal spline of a first rotary member; and
a second splined external sleeve surface for engagement with a second internal spline of a second rotary member to inhibit relative movement between the first rotary member and the second rotary member, wherein the first splined external sleeve surface is displaced radially from the second splined external sleeve surface.

11. An assembly comprising:
a resilient sleeve having a first splined internal sleeve surface and a second splined internal sleeve surface;
a first rotary member having an external spline; and
a second rotary member having an internal spline and a further spline, wherein the external spline of the first rotary member is in splined connection with the internal spline of the second rotary member and the first splined internal sleeve surface engages the external spline of the first rotary member, and wherein the second splined internal sleeve surface engages the further spline of the second rotary member to inhibit relative movement between the first rotary member and the second rotary member, the assembly forming a transmission path wherein the first rotary member is one of a driving rotary member and a driven rotary member, and the second rotary member is the other of the driving rotary member and the driven rotary member.

12. The assembly in accordance with claim 11 wherein the internal spline and the further spline of the second rotary member are formed concurrently.

13. The assembly in accordance with claim 11 wherein the first rotary member is a part of a drive shaft and the second rotary member is a brake disc, the assembly further comprising a further brake disc defining a third rotary member, wherein the brake disc includes an upstanding section perpendicular to an axis of rotation of the assembly and a base section concentric with the axis of rotation of the assembly, and wherein the further brake disc includes a further upstanding section perpendicular to the axis of rotation of the assembly and a further brake section concentric with the axis of rotation of the assembly, and wherein the brake disc and the further brake disc are arranged such that the base section of the brake disc and the further base section of the further brake disc both extend inwardly towards each other and are spaced apart to receive between them the first splined internal sleeve surface of the resilient sleeve.

14. The assembly in accordance with claim 13 wherein the base section of the brake disc and the further base section of the further brake both include a radially inner surface defining internal splines for receiving said part of said drive shaft, and the base section of the brake disc and the further base section of the further brake disc both include a radially outer surface defining external further splines for receiving the second splined internal sleeve surface and a third splined internal sleeve surface, respectively, of the resilient sleeve.

15. A vehicle comprising:
an assembly comprising:
a resilient sleeve having a first splined internal sleeve surface having first teeth and a second splined internal sleeve surface having second teeth;
a part of a drive shaft having an external spline; and
a brake disc having an internal spline and a further spline, wherein the external spline of the part of a drive shaft is in splined connection with the internal spline of the brake disc, wherein the first splined internal sleeve surface engages the external spline of the part of a drive shaft, and the second splined internal sleeve surface engages the further spline of the brake disc to inhibit relative movement between the part of a drive shaft and the brake disc, the assembly forming a transmission path wherein the part of a drive shaft is one of a driving rotary member and a driven rotary member, and the brake disc is the other of the driving rotary member and the driven rotary member; and
a brake actuator operable to effect braking of the brake disc, wherein forward movement of the vehicle corresponds to a predetermined direction of rotation of the part of a drive shaft and the brake disc, and the first teeth of the first splined internal sleeve surface of the resilient sleeve are offset with respect to the second teeth of the second splined internal sleeve surface of the resilient sleeve in the predetermined direction of rotation.

16. A method of assembling a brake assembly including a part of a drive shaft including an external splined surface and a brake sub-assembly including a brake disc with an internal spline and an external spline, a further brake disc with a further internal spline and a further external spline and a resilient sleeve including a first splined internal sleeve surface for engagement with the external splined surface of the part of the drive shaft and a second splined internal sleeve surface for engagement with the external spline the brake disc and a third splined internal sleeve surface for engagement with the further external spline of the further brake disc to inhibit relative movement between the part of the drive shaft and the brake disc and the further brake disc, wherein the first splined internal sleeve surface is displaced radially from both the second splined internal sleeve surface and the third splined internal sleeve surface, the method comprising the steps of:
engaging the external spline of the brake disc with the second splined internal sleeve surface of the resilient sleeve and engaging the further external spline of the further brake disc with the third splined internal sleeve surface of the resilient sleeve;
substantially co-aligning the internal spline of the brake disc and the further internal spline of the further brake disc by the step of engaging; and
inserting the part of the drive shaft into the brake sub-assembly by engaging the external spline of the part of the drive shaft with the internal spline of the brake disc, the further internal spline of the further brake disc, and the first splined internal sleeve.
